(19) United States
(12) Patent Application Publication
(10) Pub. No.: US 2005/0265324 A1
(43) Pub. Date: Dec. 1, 2005

(54) Wireless transmission data access device with integrated charging function

(76) Inventors: Yuan-Wei Wen, Taipei City (TW); Fong-Ming Kuo, Yong Ho City (TW); Kuang-Cheng Ho, Zhong Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/902,953

(22) Filed: Aug. 2, 2004

(30) Foreign Application Priority Data
May 31, 2004 (TW) 093208578

(51) Int. Cl. H04L 12/66

(52) U.S. Cl. 370/356

(57) ABSTRACT

The present invention is related to a wireless transmission data access device with integrated charging function, which integrates a charger in wireless transmission devices with network wireless device function such as wireless transceivers, wireless routers, or wireless gateways. The device can charge the mobile wireless network devices and transmit voice and data. It promotes the convenience and practicability where the wireless transmission data access devices are difficult to mount.

### BACKGROUND OF THE INVENTION

1. Field of the Invention

The invention is related to a wireless transmission data access device with integrated charging function. It especially utilizes a method of board-to-board or all-in-one to integrate the charging function into the wireless transmission data access device and give users charging function in the mobile wireless network device.

2. Description of the Prior Art

As the gradual spread of wide band network, in an environment with VoIP (Voice over IP) function, wireless network telephones and wireless transmission data access devices are both necessary fundamental requirements.

The wireless network device (such as: Wi-Fi VoIP Phone`Wi-Fi with GPRS combo VoIP Phone`Wi-Fi with GSM combo VoIP Phone`Wi-Fi with PHS combo VoIP Phone, Wi-Fi with WCDMA combo VoIP Phone`PDA Software IP Phone, etc.) provides the convenience of bringing. It comprises cells which can be charged over and over again as voltage/current sources and must match a charge set to ensure sufficient electric power for use. The wireless transmission data access device (Wireless Wi-Fi AP Device) comprises a wireless access point, a wireless AP router, and a wireless AP gateway to integrate wireless network transmission data access function and the wireless network device as one unit. The application of Wi-Fi transmission techniques comprises IEEE802.11b, IEEE802.11g, IEEE802.11a wireless transfer protocols.

Wireless network devices must transfer voice and data to remote destination through a wireless access point, a wireless AP router or a wireless AP gateway that have been already mounted in an environment and are authenticated by wireless system registration, and must use charger set to ensure the sufficient electric power. In an environment without any wireless network, wireless network device will be useless. However, the voltage/current source supplied to mobile wireless network device and wireless transmission data access device are independent and irrelevant. As for users, when the power of the mobile wireless network device isn't enough, users must charge it with an additional charger set. It will increase the waste of power, make it inconvenient to use, increase the space for mounting, and need to find an outlet. All of these increase the inconvenience and trouble in use.

### SUMMARY OF THE INVENTION

The main purpose of the invention is to provide a wireless transmission data access device with integrated charging function, which is a charger set integrated from the wireless transmission device with network wireless device function such as a wireless access point, a wireless AP router or a wireless AP gateway, and is used to charge the mobile wireless network device and transfer voice and data.

The other purpose of the invention is that the charger set and the wireless transmission data access device are integrated in a housing by board-to-board or all-in-one method. No matter where the wireless transmission data access device is mounted, it has the function of charging the wireless network circuit at any time and can prolong the time of use of wireless network telephones.

### BRIEF DESCRIPTION OF THE DRAWINGS

FIG. 1 illustrates the circuit diagram taking a wireless AP point as an the embodiment example;

FIG. 2 illustrates the circuit diagram taking a wireless AP router as an embodiment example;

FIG. 3 illustrates the circuit diagram taking a wireless AP gateway as an embodiment example;

FIG. 4 illustrates the housing structure diagram of the invention.

### DETAILED DESCRIPTION OF THE PREFERRED EMBODIMENTS

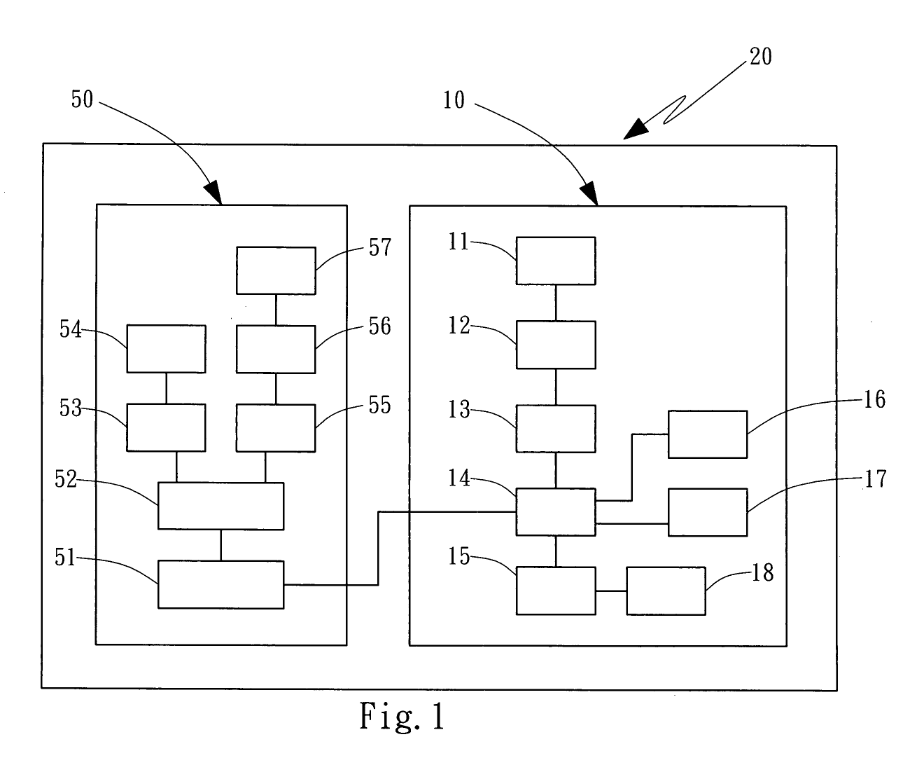

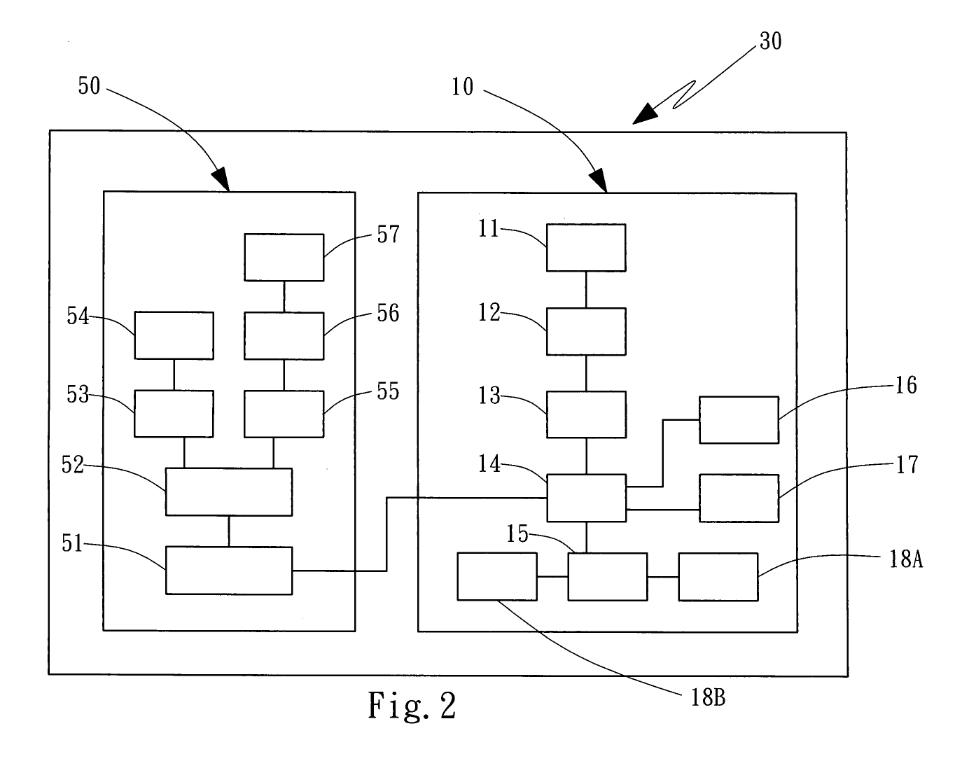

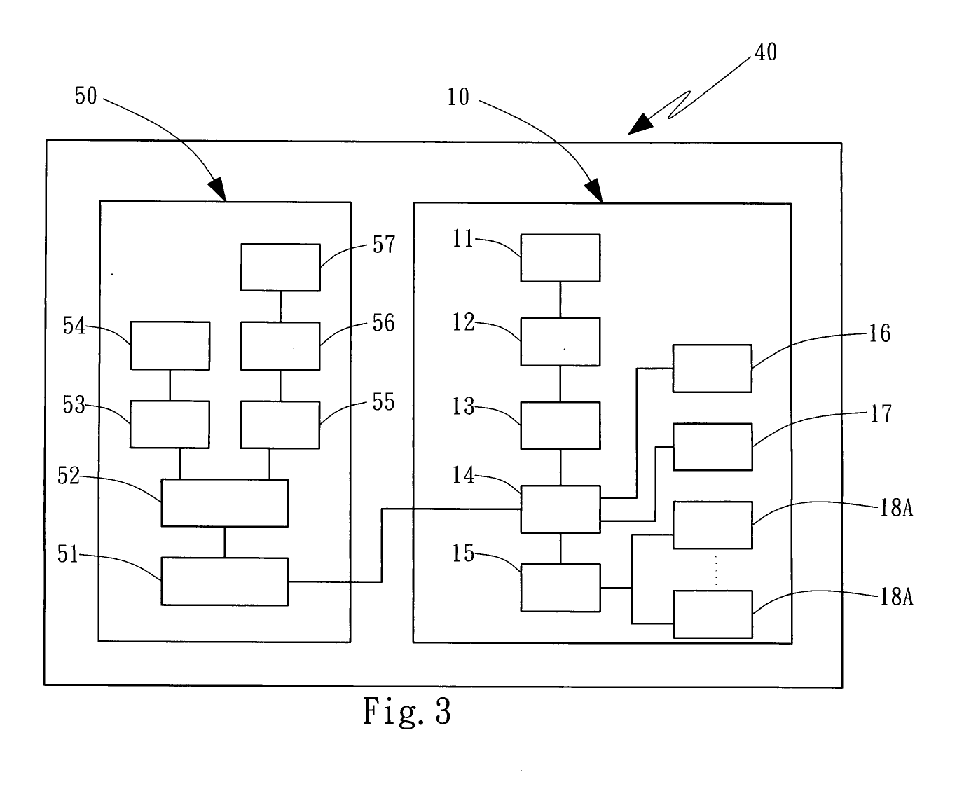

FIG. 1 illustrates the circuit diagram taking a wireless access point as an embodiment example. The circuit diagram comprises two parts. The right part is the frame of wireless transmission data access device 10, which comprises an antenna 11, a Wi-Fi wireless network card 12, a wireless interface 13, a network processor 14, a network interchange entity layer 15, a connector 18, a DRAM 16, and a flash memory 17; wherein the Wi-Fi wireless network card 12 supports IEEE802.11b`IEEE802.11g`IEEE802.11a wireless transfer protocols or integrates telecommunication techniques such as PHS, GPRS, GSM, etc. The connector 18 varies depending on the types of wireless transmission devices. For example, a wireless access point 20 uses a LAN local area network connector 18A; a wireless AP router 30 comprises a WAN wide area network connector 18B and a LAN local area network connector 18A (as shown in FIG. 2); a wireless AP gateway 40 comprises N ports LAN local area network connector 18A (as shown in FIG. 3). The voice and data transmission technique of the wireless transmission data access device is the same as the technique of the wireless transmission data access device sold in the market. The difference is that the charger set 50 on the left side of the diagram shares a voltage/current source input circuit 51 and use the same input voltage/current source.

The charger set 50 comprises a microprocessor 52, a charging indication panel 53, an error check circuit 54, a protecting circuit 55, a charging voltage check 56, and a charging current check 57. The charging techniques which we use comprise but are not restricted in large current quick charging method, voltage comparison method, and single-chip microcomputer voltage difference controlling method, etc. The embodiment example of the invention uses single-chip microcomputer voltage difference controlling method. All the components are controlled by the microprocessor 52. The voltage/current come from the voltage/current source input circuit 51 into the charger set 50. The charging current check 57 and the charging voltage check 56 controlled by the microprocessor 52 produce a suitable stable charging voltage to charge the charging cells inside the wireless network device and prevent the suddenly increasing voltage/current by the protecting circuit 55. The error check circuit 54 checks the charging status, send signals to the microprocessor 52, and drive the charging indication panel 53 to show the charging status.

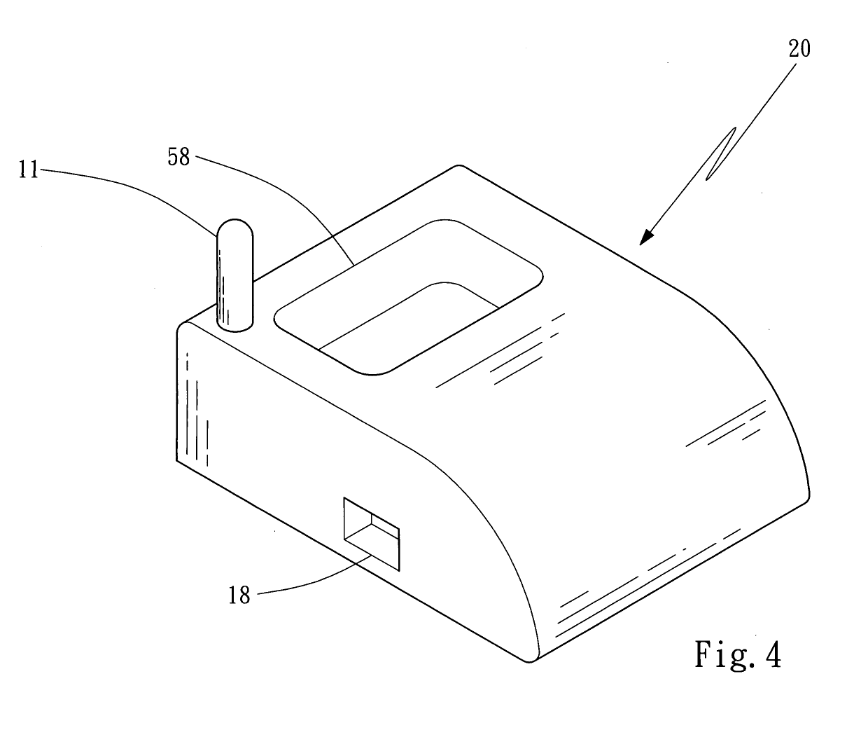

As shown in FIG. 4, it is the diagram of the housing structure of the invention. Besides the previous connector 18, in the housing of the wireless transmission data access device 10 of the invention, we add a charging mount 58, which can charge in two modes. We can put the wireless network device on the charging mount 58 to charge, or take out the charging cells from a wireless network telephone and put them on the charging mount 58 to charge. In the wireless network environment built at the location of wireless transmission data access device 10, we can charge the wireless network device at any time without needing an additional voltage/current source and a charger set. It promotes the convenience and practicality when we use it.

Thus, the wireless transmission data access device with integrated charging function which is provided by the invention not only increases the charging function besides the data and voice transmission function of the wireless transmission data access device but also promotes the convenience of use of the wireless network device. The invention never appeared before, and has the value of industry. It fits all the requirement of invention. We apply for a patent according to the law and hope it to be approved as soon as possible. Thank you very much.

We have provided a detailed description of the invention. What we have described is only one of the better embodiment examples. It can't restrict the embodiment scope of the invention. All the variation and modification according to this invention should still belong to the patent scope of the invention.

1. A kind of wireless transmission data access device with integrated charging function, comprising:
a wireless transmission data access device with voice and data transmission function which can receive the voice signals and data signals of the wireless network device through an antenna and can be linked to Internet by connectors;
a charger set used to charge the wireless network device; the previous two components are integrated to be one unit.

2. The Wireless transmission data access device with integrated charging function according to claim 1, wherein the wireless transmission data access device is the wireless access point.

3. The wireless transmission data access device with integrated charging function according to claim 1, wherein the wireless transmission data access device is the wireless AP router.

4. The wireless transmission data access device with integrated charging function according to claim 1, wherein the wireless transmission data access device is the wireless AP gateway.

5. The wireless transmission data access device with integrated charging function according to claim 1, wherein the charger set is composed of a microprocessor, a charging indication panel, an error check circuit, a protecting circuit, a charging voltage check and a charging current check. The microprocessor controls the charging current check and the charging voltage check, and produces a suitable stable charging voltage to charge the charging cells inside the wireless network device. It also prevents suddenly increasing voltage or current by the protecting circuit. The errors check circuit checks the charging status and send signals to the microprocessor to drive the charging indication panel to show the charging status.

6. The wireless transmission data access device with integrated charging function according to claim 1, wherein the charger set comprises a charging mount, we can put the wireless network device on the charging mount to charge it.

7. The wireless transmission data access device with integrated charging function according to claim 1, wherein the charger set comprises a charging mount, we can take out the charging cells from the wireless network device and put them on the charging mount to charge them.

8. The wireless transmission data access device with integrated charging function according to claim 1, wherein the wireless transmission data access device and the charger set share the same input voltage/current source.
